(19) United States
(12) Patent Application Publication
(10) Pub. No.: US 2005/0115021 A1
(43) Pub. Date: Jun. 2, 2005

(54) OFFICE CHAIR CASTER

(76) Inventor: Po-Chuan Tsai, Tainan Hsien (TW)

Correspondence Address: Po-Chuan Tsai, P.O. Box 90, Tainan City, 704, TW

(21) Appl. No.: 10/724,166

(22) Filed: Dec. 1, 2003

(51) Int. Cl. B60B 33/00

(52) U.S. Cl. 16/31 R

(57) ABSTRACT

An office chair caster has a wheel holder, a wheel body, a spindle seat and a spindle. Make a first base and a second base oppositely joined together to form the wheel holder with retaining pieces of the second base inserted into fitting slots of the first base, and make the spindle seat that is extended through by the spindle inserted into through holes of the first and second bases with engagement protuberances of the spindle seat aligned with engagement grooves of the second base. The spindle seat can be rotated at 90 degree to make the engagement protuberances impelled over projections of the first base, stopped by stop blocks of the first base, engaged in sliding slots of the second base, and limited between the projections and the stop blocks without moving, thereby the spindle seat can be firmly fixed in the wheel holder to hold the spindle securely.

### BACKGROUND OF THE INVENTION

1. Field of the Invention

This invention relates to an office chair caster, particularly to one capable of firstly having a first base and a second base oppositely joined together to form a wheel holder with a plurality of retaining pieces of the second base inserted into a plurality of fitting slots of the first base, further having a spindle extending through a spindle bore of a spindle seat, and then having the spindle seat inserted into through holes of the first base and the second base with a plurality of engagement protuberances of the spindle seat aligned with a plurality of engagement grooves of the second base, by which the spindle seat can be rotated at 90 degree to make the engagement protuberances of the spindle seat impelled over a plurality of projections that are disposed in an inner wall surface of the through hole of the first base, stopped by a plurality of stop blocks that are also disposed in the inner wall surface of the through hole of the first base, simultaneously engaged in a plurality of sliding slots of the second base, and thus limited between the projections and the stop blocks without moving further, thereby the spindle seat can be firmly fixed in the wheel holder to hold the spindle securely without worry of the spindle coming loose.

2. Description of the Prior Art

Generally speaking, a known conventional office chair caster 1, as shown in FIG. 1, has an integrally-made wheel holder 10 whose upper portion is extended through by a spindle 11 that is provided with external threads and capable of being fixedly screwed to the wheel holder 10 by a nut 12, and whose lower portion is pivoted with a wheel body 14 by a pivot 13. However, such an office chair caster 1 designed to have the spindle 11 screwed to the wheel holder 10 by the nut 12 may become unsteady and noisy in rolling wheel body 14 because the nut 12 is liable to become loose after long-termed swiveling of the spindle 11.

### SUMMARY OF THE INVENTION

The main purpose of the invention is to offer an office chair caster being convenient in assembling and steady in rolling without worry of a spindle coming loose.

The main feature of the invention is to provide an office chair caster mainly including:
a wheel holder having a first base and a second base oppositely joined together;
the first base having a recess disposed thereon, an opening disposed at one side thereof, a rod housing disposed in an interior thereof and a cover plate integrally disposed at a lower portion thereof, the recess provided with a through hole disposed therein, the through hole provided with a plurality of fitting slots disposed on a wall thereof and extending therethrough in communication with the opening, the through hole also provided with a plurality of stop blocks oppositely disposed on an inner wall surface thereof and a plurality of projections oppositely disposed on the inner wall surface thereof;
the second base having a through hole disposed thereon, a plurality of retaining pieces protruded from one side thereof corresponding to the plurality of fitting slots of the first base, a rod housing disposed in an interior thereof corresponding to the rod housing of the first base and a cover plate integrally disposed at a lower portion thereof, the through hole provided with a plurality of sliding slots disposed on a wall thereof, each of the sliding slots located between every two of the retaining pieces and extending therethrough in communication with the side of the second base that is protruded with the plurality of retaining pieces, the through hole also provided with two engagement grooves oppositely disposed on an inner wall surface thereof, a connecting rod having both ends respectively fixed in the rod housings of the first base and the second base;
a wheel body capable of being mounted between the cover plates of the first base and the second base;
a spindle seat capable of being combined in the through holes of the first base and the second base, and having a flange disposed at an upper end thereof, a spindle bore disposed in a center thereof, and a plurality of engagement protuberances oppositely disposed on an outer wall surface thereof; and,
a spindle capable of being accommodated in the through holes of the first base and the second base and extending through the spindle bore of the spindle seat, the spindle having a stop flange disposed at a lower end thereof.

### BRIEF DESCRIPTION OF DRAWINGS

This invention will be better understood by referring to the accompanying drawings, wherein:

FIG. 1 is a perspective view of a known conventional caster;

FIG. 2 is an exploded perspective view of an office chair caster in the present invention;

FIG. 3 is a perspective view of the office chair caster in the present invention;

FIG. 4 is a sectional view showing an assemblage of a wheel body of the office chair caster in the present invention;

FIG. 5 is a sectional view showing an assemblage of a first base and a second base of the office chair caster in the present invention, in which a spindle seat is in an unlocked condition;

FIG. 6 is a sectional view taken along section line A-A of the FIG. 5;

FIG. 7 is a sectional view showing an assemblage of the first base and the second base of the office chair caster in the present invention, in which the spindle seat is rotated to be in a locked condition; and,

FIG. 8 is a sectional view taken along section line B-B of the FIG. 7.

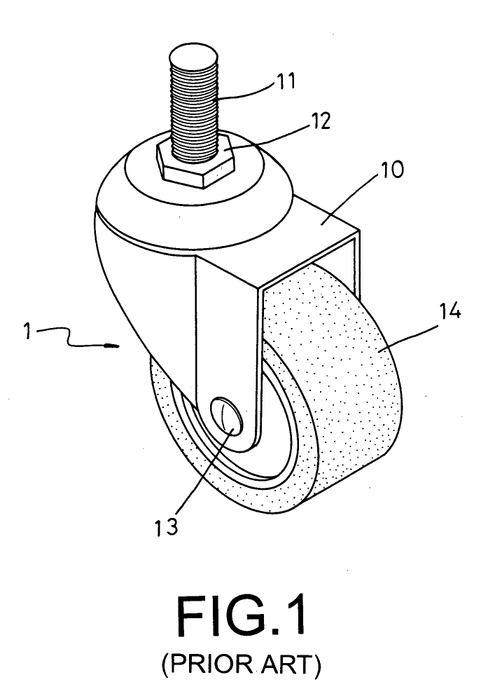

### DETAILED DESCRIPTION OF THE PREFERRED EMBODIMENT

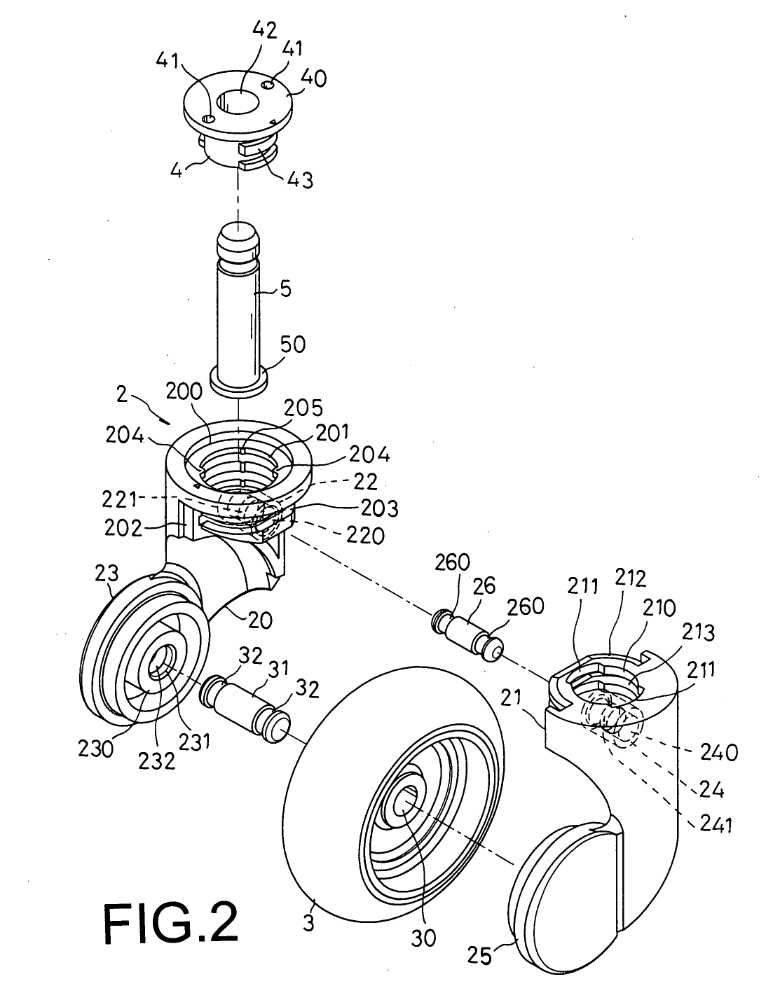

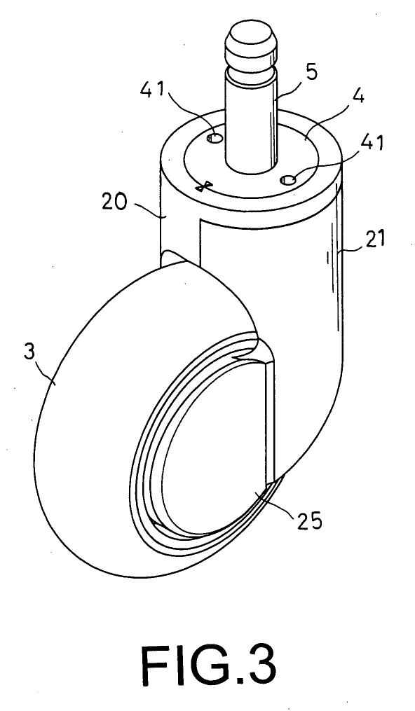

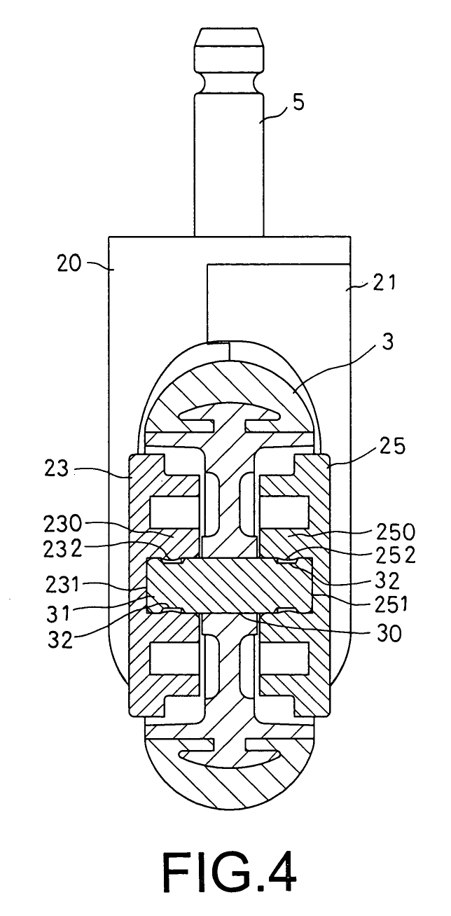

A preferred embodiment of an office chair caster in the present invention, as shown in FIGS. 2, 3 and 4, mainly includes a wheel holder 2, a wheel body 3, a spindle seat 4 and a spindle 5.

The wheel holder 2 has a first base 20 and a second base 21 oppositely joined together.

The first base 20 has a recess 200 disposed thereon, an opening 202 disposed at one side thereof, a rod housing 22 disposed in an interior thereof and a cover plate 23 integrally disposed at a lower portion thereof. The recess 200 is provided with a through hole 201 disposed therein. The through hole 201 is provided with a plurality of fitting slots 203 disposed on a wall thereof and extending therethrough in communication with the opening 202. The through hole 201 is also provided with a plurality of stop blocks 204 oppositely disposed on an inner wall surface thereof and a plurality of projections 205 oppositely disposed on the inner wall surface thereof. The rod housing 22 has a rod hole 220 disposed therein. The rod hole 220 is provided with a circumferential ridge 221 protruded on an inner wall surface thereof. The cover plate 23 has an axle housing 230 disposed therein and provided with an axle hole 231 in which a circumferential ridge 232 protruded thereon.

The second base 21 having a through hole 210 disposed thereon, a plurality of retaining pieces 212 protruded at one side thereof corresponding to the plurality of fitting slots 203 of the first base 20, a rod housing 24 disposed in an interior thereof corresponding to the rod housing 22 of the first base 20 and a cover plate 25 integrally disposed at a lower portion thereof. The through hole 210 is provided with a plurality of sliding slots 213 disposed on a wall thereof. Each of sliding slots 213 is located between every two of the retaining pieces 212 and extends therethrough in communication with the side that is protruded with the retaining pieces 212. The through hole 210 is also provided with two engagement grooves 211 oppositely disposed on an inner wall surface thereof. The rod housing 24 has a rod hole 240 disposed therein. The rod hole 240 is provided with a circumferential ridge 241 protruded thereon an inner wall surface thereof. The cover plate 25 has an axle housing 250 disposed therein and provided with an axle hole 251 in which a circumferential ridge 252 protruded thereon. A connecting rod 26 having both ends respectively fixed in the rod housings 22, 24 of the first base 20 and the second base 21 and each of the ends is provided with a ring groove 260 thereon.

The wheel body 3 capable of being mounted between the cover plates 23, 25 of the first base 20 and the second base 21 has an axle hole 30 disposed therein for being passed through by a wheel axle 31. The wheel axle 31 has both ends and each of the ends is provided with a ring groove 32 thereon.

The spindle seat 4 capable of being combined in the through holes 201, 210 of the first base 20 and the second base 21 has a flange 40 disposed at an upper end thereof, a spindle bore 42 disposed in a center thereof and a plurality of engagement protuberances 43 oppositely disposed on an outer wall surface thereof. The flange 40 is provided with at least one hole 41 disposed thereon.

The spindle 5 capable of being accommodated in the through holes 201, 210 of the first base 20 and the second base 21 and extending through the spindle bore 42 of the spindle seat 4 has a stop flange 50 disposed at a lower end thereof.

In assembling, referring to FIGS. 2, 3, 4 and 5, firstly have one end of the connection rod 26 inserted into the rod hole 220 of the rod housing 22 of the first base 20 with one of the ring grooves 260 of the connecting rod 26 engaged by the circumferential ridge 221 of the rod hole 220.

Secondly, have one end of the wheel axle 31 inserted into the axle hole 231 of the cover plate 23 of the first base 20 with one of the ring grooves 32 of the wheel axle 31 engaged by the circumferential ridge 232 of the axle hole 231.

Thirdly, have the wheel body 3 sleeved on the wheel axle 31.

Fourthly, have the second base 21 oppositely joined together with the first base 20 with the wheel body 3 located between the cover plates 23, 25 of the first base 20 and the second base 21, and then have another end of the wheel axle 31 inserted into the axle hole 251 of the cover plate 25 of the second base 21 with another one of the ring grooves 32 of the wheel axle 31 engaged by the circumferential ridge 252 of the axle hole 251, thereby making the wheel body 3 firmly mounted between the cover plates 23, 25 of the first base 20 and the second base 21.

Fifthly, have the retaining pieces 212 of the second base 21 inserted into the fitting slots 203 of the first base 20, and then have another end of the connection rod 26 inserted into the rod hole 240 of the rod housing 24 of the first base 21 with another one of the ring grooves 260 of the connecting rod 26 engaged by the circumferential ridge 241 of the rod hole 240, thereby making the first base 20 and the second base 21 oppositely joined together to form the wheel holder 2.

Sixthly, have the spindle 5 upwardly extending through the spindle bore 42 of the spindle seat 4 from a lower end of the spindle bore 42 until the stop flange 50 of the spindle 5 is stopped by a bottom of the spindle seat 4.

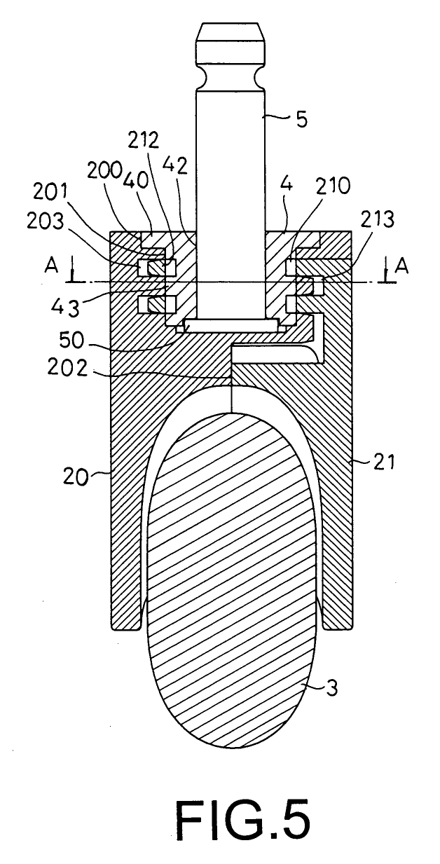

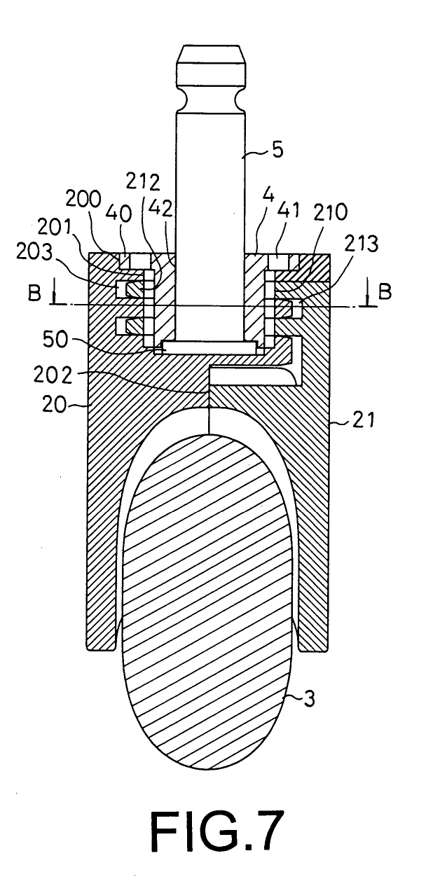

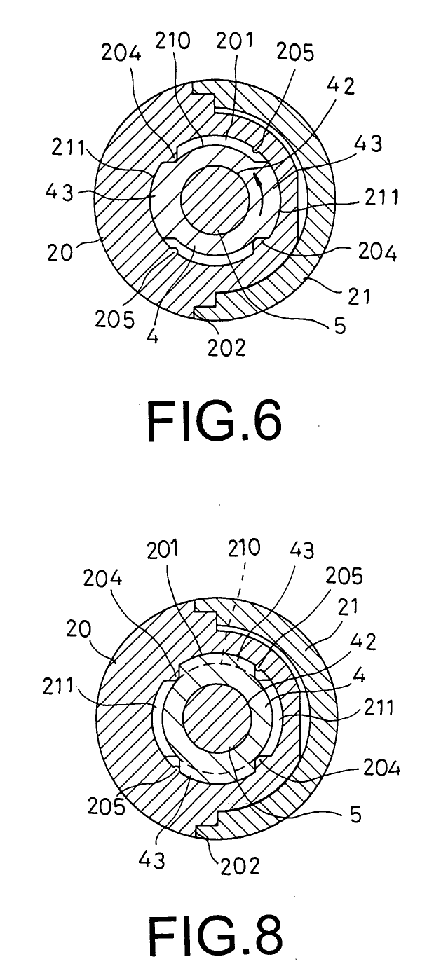

Seventhly, have the spindle seat 4 and the spindle 5 placed into the through holes 201, 210 of the first base 20 and the second base 21 of the combined wheel holder 2 with the engagement protuberances 43 of the spindle seat 4 aligned with the engagement grooves 211 of the second base 21, as shown in FIGS. 5 and 6, and with the flange 40 of the spindle seat 4 placed in the recess 200 of the first base 20.

Finally, have the hole 41 of the spindle seat 4 inserted by a tool to rotate the spindle seat 4 at 90 degree to make the engagement protuberances 43 of the spindle seat 4 impelled over the projections 205 of the through hole 201 of the first base 20, stopped by the stop blocks 204 of the through hole 201 of the first base 21, simultaneously engaged in the sliding slots 213 of the second base 21, and thus limited between the projections 205 and the stop blocks 204 without moving further, as shown in FIGS. 7 and 8, thereby the spindle seat 4 can be firmly fixed in the wheel holder 2 to hold the spindle 5 securely without worry of the spindle 5 coming loose, by which an assemblage of the whole structure of the office chair caster in the present invention is completed, very convenient in assembling.

Moreover, the spindle 5 firmly held by the spindle seat 4 will not become loose and have longer use life so as to make the office chair caster steady in rolling without noise.

While the preferred embodiment of the invention has been described above, it will be recognized and understood that various modifications may be made therein and the appended claims are intended to cover all such modifications that may fall within the spirit and scope of the invention.

1. An office chair caster comprising:
a wheel holder having a first base and a second base oppositely joined together;
said first base having a recess disposed thereon, an opening disposed at one side thereof, a rod housing disposed in an interior thereof and a cover plate integrally disposed at a lower portion thereof, said recess provided with a through hole disposed therein, said through hole provided with a plurality of fitting slots disposed on a wall thereof and extending therethrough in communication with said opening, said through hole also provided with a plurality of stop blocks oppositely disposed on an inner wall surface thereof and a plurality of projections oppositely disposed on said inner wall surface thereof;
said second base having a through hole disposed thereon, a plurality of retaining pieces protruded from one side thereof corresponding to said plurality of fitting slots of said first base, a rod housing disposed in an interior thereof corresponding to said rod housing of said first base and a cover plate integrally disposed at a lower portion thereof, said through hole provided with a plurality of sliding slots disposed on a wall thereof, each of said sliding slots located between every two of said retaining pieces and extending therethrough in communication with said side of said second base that is protruded with said plurality of retaining pieces, said through hole also provided with two engagement grooves oppositely disposed on an inner wall surface thereof, a connecting rod having both ends respectively fixed in said rod housings of said first base and said second base;
a wheel body capable of being mounted between said cover plates of said first base and said second base;
a spindle seat capable of being combined in said through holes of said first base and said second base, and having a flange disposed at an upper end thereof, a spindle bore disposed in a center thereof, and a plurality of engagement protuberances oppositely disposed on an outer wall surface thereof; and,
a spindle capable of being accommodated in said through holes of said first base and said second base and extending through said spindle bore of said spindle seat, said spindle having a stop flange disposed at a lower end thereof.

2. The office chair caster as claimed in claim 1, wherein said flange of said spindle seat has at least one hole disposed thereon.
